(19) United States
(12) Patent Application Publication
(10) Pub. No.: US 2025/0333323 A1
(43) Pub. Date: Oct. 30, 2025

(54) Mineralizing Carbon Dioxide into Sustainable Materials

(71) Applicant: UNM RAINFOREST INNOVATIONS, Albuquerque, NM (US)

(72) Inventors: Sungjin KIM, Albuquerque, NM (US); Sang M. HAN, Albuquerque, NM (US); Sang Eon HAN, Albuquerque, NM (US); Maryam HOJATI, State College, PA (US)

(73) Assignee: UNM RAINFOREST INNOVATIONS, Albuquerque, NM (US)

(21) Appl. No.: 19/189,589

(22) Filed: Apr. 25, 2025

Related U.S. Application Data
(60) Provisional application No. 63/639,145, filed on Apr. 26, 2024.

(51) Int. Cl. C01F 11/18

(52) U.S. Cl. CPC C01F 11/181; C01P 2002/02; C01P 2002/70; C01P 2004/04; C01P 2004/34; C01P 2004/61; C01P 2004/62

(57) ABSTRACT

A sustainable material and method for fabricating sustainable materials is disclosed. The method includes injecting carbon dioxide gas into a reaction vessel, injecting a mixture including calcium and ammonium hydroxide (NH₄OH) into the reaction vessel, incorporating polymeric additives into the reaction vessel, and producing calcium carbonate (CaCO₃) from the reaction vessel. Implementations of the method for fabricating sustainable materials can include where the mixture includes calcium chloride (CaCl₂). The method for fabricating sustainable materials may include adjusting one or more physical parameters to control a phase transition of calcium carbonate (CaCO₃). The one or more physical parameters may include a bubble size of the carbon dioxide gas, injection rate of the carbon dioxide gas, injection rate of calcium chloride (CaCl₂), injection rate of ammonium hydroxide (NH₄OH), temperature, or combinations thereof. The polymeric additives may include bioderived polymers, such as polydopamine, tannins, flavonoids, gallic acids, or combinations thereof.

### REFERENCE TO RELATED APPLICATIONS

This application claims the benefit of U.S. Provisional Patent Application No. 63/639,145, filed on Apr. 26, 2024, which is hereby incorporated by reference in its entirety.

### TECHNICAL FIELD

The present teachings relate generally to processes for mineralizing carbon dioxide and, more particularly, to mineralized materials thereof for sustainable materials.

### BACKGROUND

The challenge of transforming carbon dioxide (CO2) gas into inorganic materials with sustainable, high-value applications can offer a timely and effective strategy to mitigate current climate challenges. For example, heat-reflective cool roof coatings are a promising application for reducing energy consumption and greenhouse gas emissions from buildings and constructions.

Current ways to utilize CO₂ gas by conversion to other materials include polymer and plastic manufacturing, for example, polycarbonate plastics or polyurethane foams, construction materials utilizing carbon dioxide, fuels and chemicals, food and beverages, carbon nanomaterials, or other specialty chemicals. These methods of carbon dioxide utilization require substantial energy costs, scalability issues, and competition from existing technologies.

Therefore, if the development of new methods or manufacturing path that utilizes CO₂ to produce high-value materials with practical applications to reduce carbon footprint, having lowered costs and scalability, such an approach can provide multipath solutions that address current environmental concerns.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A method for fabricating sustainable materials is disclosed. The method includes injecting carbon dioxide gas into a reaction vessel, injecting a mixture including calcium and ammonium hydroxide (NH₄OH) into the reaction vessel, incorporating polymeric additives into the reaction vessel, and producing calcium carbonate (CaCO₃) from the reaction vessel.

Implementations of the method for fabricating sustainable materials can include where the mixture includes calcium chloride (CaCl₂). The method for fabricating sustainable materials may include adjusting one or more physical parameters to control a phase transition of calcium carbonate (CaCO₃). The one or more physical parameters may include a bubble size of the carbon dioxide gas, injection rate of the carbon dioxide gas, injection rate of calcium chloride (CaCl₂), injection rate of ammonium hydroxide (NH₄OH), temperature, or combinations thereof. The temperature is from about 0° C. to about 90° C. The polymeric additives may include bioderived polymers, such as polydopamine, tannins, flavonoids, gallic acids, or combinations thereof. The method for fabricating sustainable materials may include optimizing a concentration of calcium chloride (CaCl₂). The method for fabricating sustainable materials may include adjusting a concentration of ammonium hydroxide (NH₄OH) to control a phase transition of calcium carbonate (CaCO₃). The calcium carbonate (CaCO₃) may include a plurality of hollow microspheres. The plurality of hollow microspheres of calcium carbonate (CaCO₃) may include a shell thickness of from about 50 nm to about 1 micron and a diameter of from about 0.5 microns to about 10 microns. The method for fabricating sustainable materials may include analyzing crystalline phase and particle size distribution of calcium carbonate (CaCO₃) using powder x-ray diffraction (XRPD). The method for fabricating sustainable materials may include analyzing surface properties of calcium carbonate (CaCO₃) using microscopy techniques such as confocal laser scanning microscopy (CLSM) or atomic force microscopy (AFM). Implementations of the described techniques may include hardware, a method or process, or computer software on a computer-accessible medium.

A material is disclosed. The material includes a hollow calcium carbonate microsphere, where the hollow calcium carbonate microsphere has a hollow core that may include a diameter of from about 0.5 microns to about 10 microns. The material also includes where the hollow calcium carbonate microsphere has a shell thickness of from about 50 nm to about 1 micron. The material also includes where the hollow calcium carbonate microsphere has an external diameter of from about 0.5 microns to about 10 microns. Implementations of the material can include where the hollow calcium carbonate microsphere include a vaterite polyphase. The hollow calcium carbonate microsphere can be amorphous.

A method for mineralizing carbon dioxide is disclosed. The method for mineralizing carbon dioxide includes injecting carbon dioxide gas into a reaction mixture of calcium and ammonium hydroxide. The method can include injecting one or more polymers into the reaction mixture. The method can further include forming calcium carbonate, ammonium chloride, and water, and where the calcium carbonate may include a plurality of hollow microspheres.

Implementations of the method for mineralizing carbon dioxide include where the one or more polymers may include catecholic polymers, phenolic polymers, or a combination thereof. The one or more polymers may include polydopamine, tannins, flavonoids, gallic acids, or a combination thereof. The plurality of hollow microspheres may include a particle size of from about 0.5 microns to about 5 microns and a wall thickness of about 10 nm to about 1 micron.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 is a schematic diagram illustrating a direct CO₂ storage and CaCO₃ synthesis approach to produce custom engineered materials, in accordance with the present disclosure.

FIG. 2 is a flowchart illustrating a method for fabricating sustainable materials, in accordance with the present disclosure.

FIG. 3 is a flowchart illustrating a method for mineralizing carbon dioxide, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

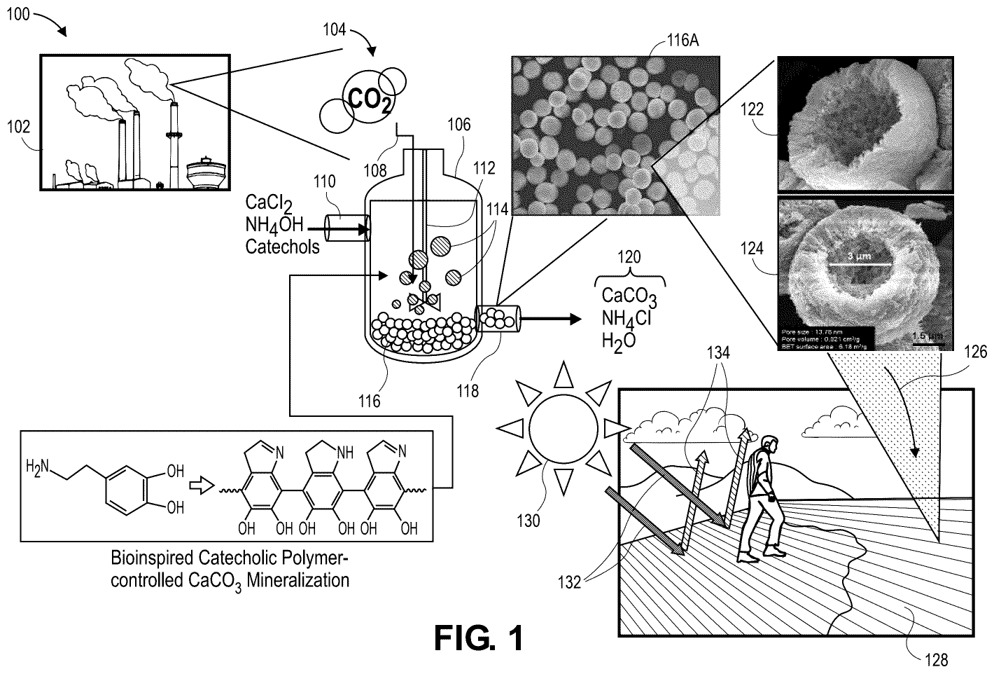

The present disclosure provides a method for storing CO₂ gas in the form of calcium carbonate (CaCO₃) minerals that can replace or supplement conventional critical minerals for cool roof coating applications (e.g., titania, alumina, zinc oxide or barite) which carry a supply chain risk as well as carbon-intensive lifecycle with no necessary storability of CO₂. To accomplish this, the present teachings provide the development of a process including bioinspired, environment-friendly, and room-temperature processes using natural chemical species, where catecholic or phenolic polymers control the phase of CaCO₃ to obtain hollow microspheres via direct CO₂ bubble-templated mineralization. The investigation of the fundamental chemical kinetics and fluid dynamics can further provide sufficient information to tailor the material and structure parameters of hollow CaCO₃ microspheres, such as material phase, wall thickness, particle size, and morphology, to maximize solar reflectivity. This approach can provide a multifaceted sustainable and scalable material solution that can directly store CO₂ in its production cycle and further reduce carbon emission through its application as a heat reflector, which in return helps conserve critical minerals. Results shown in FIG. 1 show hollow CaCO₃ spheres with dimensions in micron scale highly desirable as a cool rooftop coating component.

FIG. 1 is a schematic diagram illustrating a direct CO₂ storage and CaCO₃ synthesis approach to produce custom engineered materials, in accordance with the present disclosure. The process for direct CO₂ storage and CaCO₃ synthesis approach 100 shown in FIG. 1 provides a sustainable pathway to directly mineralize CO₂ from various industrial sources 102 into high-value hollow microspheres that can be used as solar reflective coating materials for enhancing household energy efficiency, as an example. The CO₂ 104 can be introduced into a reactor vessel 106 via an inlet 108, where the rate of gas introduction can be regulated. Additional reactants, such as, for example, calcium-based materials like calcium chloride (CaCl₂), ammonium hydroxide (NH₄OH) and various catechols or other polymers can be introduced into the reactor vessel 106 via a reactant inlet 110. In examples, the contents of the reactor vessel 106 can be agitated by a stirring mechanism 112 or similar apparatus known to one skilled in the art. Within the reactor vessel 106 the mobile reactants 114 combine to produce a calcium carbonate (CaCO₃) 116 and can be collected via a reactor vessel outlet 118, along with other products 120, including ammonium chloride (NH₄Cl) and water (H₂O). Also shown in FIG. 1 is a magnification of the microspheres of calcium carbonate (CaCO₃) 116A produced in the process for direct CO₂ storage and CaCO₃ synthesis approach 100. Further magnified images show individual calcium carbonate (CaCO₃) microspheres 122, 124 showing detailed morphology and dimensions of the calcium carbonate (CaCO₃) microspheres 122, 124. Also depicted in FIG. 1 is an example application 126 for use of such calcium carbonate (CaCO₃) microspheres 122, 124 in materials used in rooftop 128 coating or material applications, that provide the ability of the rooftop 128 material or coating to reflect 134 rays 132 from the sun 130, thus providing solar reflectivity.

These microspheres, characterized by a distinctive hollow morphology providing added interfaces for enhanced light scattering, can be utilized for applications in cool roof coatings, other radiative cooling materials, or in concrete materials, offering a sustainable alternative to conventional critical mineral-based coating materials. Therefore, this approach reduces carbon footprints in building lifecycles beyond the immediate energy savings by the solar reflective coating applications because the manufacturing of these materials can directly store CO₂ around room temperature. Moreover, they bypass supply risks as well as the heavy carbon footprint associated with the manufacturing of critical mineral-based materials traditionally used in similar applications. Applications for the microspheres and materials of the present disclosure include, but are not limited to concrete and construction materials, where they can be incorporated into concrete to improve thermal insulation, reduce density, and enhance durability, while also providing direct CO₂ storage benefits; paints and coatings-their light-scattering properties can be utilized in high-reflectance paints, enhancing brightness and reducing heat absorption; plastics and polymers as lightweight fillers, they can improve mechanical properties and reduce the carbon footprint of plastic products; pharmaceuticals, where hollow CaCO₃ microspheres can serve as carriers for drug delivery due to their biocompatibility and controlled release capabilities. Other applications include the paper industry, used as a coating pigment or filler to improve brightness, opacity, and printability; cosmetics, where their smooth, spherical morphology makes them suitable for use in powders and creams, providing desirable texture and light-diffusing effects; catalyst supports, in which high surface area and tunable porosity make them useful as supports for catalysts in chemical reactions; water treatment, utilized for removal of heavy metals or as a pH regulator in water purification processes; food and nutritional supplements, as a calcium fortifier in edible forms (non-hollow microspheres typically used); and biomedical scaffolds, where their morphology and biodegradability make them candidates for bone regeneration materials.

In addition to such practical applications, the approach of the present disclosure can provide additional information related to the fundamental mechanisms behind CO₂-storing mineralization in interaction with bioderived polymer additives. First, the present teachings provide understanding as to how adjusting physical parameters such as CO₂ injection rate and bubble size can enhance CO₂ storage efficiency. Also, strategies to control CO₂-templated mineralization to produce hollow microspheres with tailored shell thickness, sizes of hollow core and microsphere can also be provided by methods of the present disclosure. Second, by using polymeric additives derived from natural sources like mussels, vegetables, or fruits, the universal or distinctive role of these bioderived sources can be leveraged in stabilizing desirable metastable microspherical phases, preventing transition to typical, stable rhombohedral calcites. Therefore, the present teachings provide present bioderived, bio-friendly, low carbon footprint chemical additives and their mechanism to control CO₂ mineralization to secure the desired mineral polymorph. These concepts together lead to a better understanding of Earth's biomineralization and geochemical processes orchestrated by organic-inorganic interaction, drawing inspiration from the intricately controlled storage of CO₂ in biominerals found in corals, coccoliths, foraminifera, and mollusk shells. More broadly, the present teachings can contribute cleaner technological implementations, potentially transforming the carbon-intensive building industry.

The methods and processes described herein provide a sustainable approach for direct CO₂ mineralization, resulting in high-value hollow CaCO₃ microspheres. The method involves injecting CO₂ gas into a reaction mixture of a calcium-based material, such as calcium chloride (CaCl₂), and ammonium hydroxide (NH₄OH), resulting in the formation of CaCO₃, ammonium chloride (NH₄Cl), and water, all of which are chemicals found in nature. Central to the mineralization process is the incorporation of bioderived polymeric additives, including polydopamine, tannins, flavonoids, and gallic acids. Additional materials can include lignin, quercetin, ellagic acid, caffeic acid, chitosan, pyrogallols, resorcinol, polyacrylic acid. It should be noted that polyacrylic acid is not necessarily bioderived. While the ability of polydopamine to stabilize the vaterite phase has been shown, whether or how such phase selectivity in CO₂ mineralization can be generalized or specific to different catecholic or phenolic polymers can be provided by the method as described herein. Therefore, one or more of these additives can play a specific role in stabilizing metastable phases of CaCO₃, particularly vaterites and amorphous CaCO₃ (ACC), contributing to the development of microspherical structures. The present teachings therefore provide various bioderived or bioinspired catecholic or phenolic polymers for their effectiveness in controlling the phase transition of CaCO₃.

Another focus of the present disclosure is defining the parameters of the CO₂ gas bubble-templated mineralization process. The CO₂ mineralization rates, yields, particle sizes, and hollow structures can be established by manipulating parameters such as CO₂ bubble size, injection rate, ingredient concentrations, and temperature. Techniques including X-ray diffractometry (XRD) and microscopy (SEM, TEM, or confocal) can be employed to characterize material phases, morphologies, and hollow structures. It is known that a few micrometers (μm) size of particles provide the best solar reflectance. A s most visible bubbles are in millimeters (mm) scale, the focus of the method addresses how bubble-templated mineralization can form hollow structures in um scale. To further enhance the visual observation of this mineralization process, fluorescent dyes or pigments can be introduced, and high-speed cameras can capture their interaction with CO₂ bubbles under mineralization. The CO₂ mineralization rate is assessed by measuring the CaCO₃ mass obtained per time and the yield can be obtained by comparing the rates of mineralization and CO₂ input. Finally, the resulting hollow CaCO₃ minerals and their performance as reflective materials in cool roof coatings can be evaluated and compared with conventional critical mineral-based materials. The addition of fluorescent dyes or pigments can enhance the visual observation of the CO₂ mineralization process, and high-speed cameras can capture their interaction with CO₂ bubbles under mineralization.

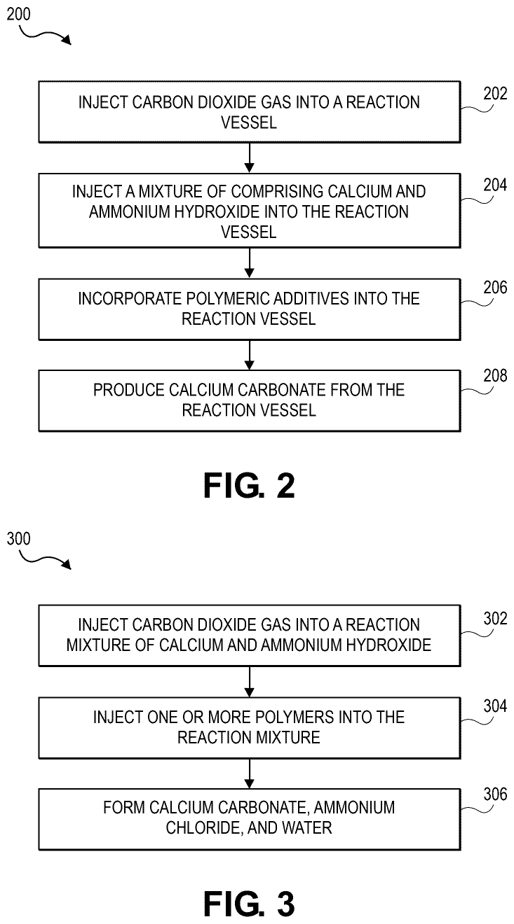

FIG. 2 is a flowchart illustrating a method for fabricating sustainable materials, in accordance with the present disclosure. The method 200 for fabricating sustainable materials, includes the steps of injecting carbon-dioxide gas into a reaction vessel 202, injecting a mixture of calcium and ammonium hydroxide (NH₄OH) into the reaction vessel 204, incorporating polymeric additives into the reaction vessel 206, and producing calcium carbonate (CaCO₃) from the reaction vessel 208. In examples, the method 200 can further include adjusting one or more physical parameters to control a phase transition of calcium carbonate (CaCO₃). For example, one of more physical parameters comprise a bubble size of the carbon dioxide, injection rate of the carbon dioxide, injection rate of calcium chloride (CaCl₂), injection rate of ammonium hydroxide (NH₄OH), temperature, or combinations thereof. The polymeric additives can include bioderived polymers, such as polydopamine, tannins, flavonoids, gallic acids, or combinations thereof. Addition steps in the method 200 can include optimizing a concentration of calcium chloride (CaCl₂), operating in a temperature range of mineralization from about 25° C. to about 35° C. The adjustment of a concentration of ammonium hydroxide (NH₄OH) can be used to control a phase transition of calcium carbonate (CaCO₃). The method 200 produces calcium carbonate (CaCO₃) in the form of a plurality of hollow microspheres. This plurality of hollow microspheres of calcium carbonate (CaCO₃) can have a shell thickness of from about 50 nm to about 1 micron or from about 50 nm to about 200 nm, or an external diameter of from about 0.5 microns to about 10 microns. Further aspects of the method 200 include analyzing crystalline phase and particle size distribution of calcium carbonate (CaCO₃) using powder X-ray diffraction (XRPD) or analyzing surface properties of calcium carbonate (CaCO₃) using microscopy techniques such as confocal laser scanning microscopy (CLSM) or atomic force microscopy (AFM).

FIG. 3 is a flowchart illustrating a method for mineralizing carbon dioxide, in accordance with the present disclosure. The method 300 for mineralizing carbon dioxide includes the steps of injecting carbon dioxide gas into a reaction mixture of calcium chloride and ammonium hydroxide 302, injecting one or more polymers into the reaction mixture 304, and forming calcium carbonate, ammonium chloride, and water 306, and wherein the calcium carbonate comprises a plurality of hollow microspheres. The method 300 can include wherein the one or more polymers comprise catecholic polymers, phenolic polymers, or a combination thereof. The method can also include wherein the one or more polymers comprise polydopamine, tannins, flavonoids, gallic acids, or a combination thereof. The plurality of hollow microspheres produced can have a particle size of from about 0.5 microns to about 5 microns, or from about 200 nm to about 10 microns, and a wall thickness of about 10 nm to about 1 micron or from about 10 nm to about 200 nm, or from about 10 nm to about 2000 nm. In examples, the temperature of reaction can be controlled at a temperature of from about 0° C. to about 90° C. In such examples, lower temperatures can slow reaction kinetics, where higher temperatures can destabilize ACC or vaterite. In other examples, pH can be controlled in a range of about 5 to about 13, and reaction time can range from about 1 minute to 16 hours, or from about 60 minutes to about 24 hours.

The CO₂ mineralization process using calcium chloride (CaCl₂) or other materials including calcium, such as, but not limited to calcium nitrate (Ca(NO₃)₂), calcium acetate (Ca(C₂H₃O₂)₂), Calcium lactate (Ca(C₃H₅O₃)₂), or Calcium gluconate (Ca(C₆H₁₁O₇)₂), Calcium Hydroxide (Ca(OH)₂), Calcium Oxide (CaO), Calcium Sulfate (CaSO₄), and ammonium hydroxide (NH₄OH) produces a sustainable approach to directly transform carbon dioxide (CO₂) gas into high-value inorganic materials with practical applications for reducing energy consumption and greenhouse gas emissions from buildings and constructions. This process involves injecting CO₂ gas into a reaction mixture of CaCl₂ and NH₄OH, which results in the formation of calcium carbonate (CaCO₃), ammonium chloride (NH₄Cl), and water. The optimal reaction conditions for successful mineralization include a CaCl₂ concentration of from about 0.1 M to about 2 M, or from about 0.5 to about 1 M, NH₄OH concentration of from about 0.1M to about 3M, or from about 0.5 to about 1 M, a pH between about 5 and about 13, or between about 8 and about 9, and a temperature range of from about 0° C. to about 90° C., or from about 25° C. to about 35° C.

The reaction time can vary depending on the desired product formation but typically ranges from several hours to overnight. This process offers a timely and effective strategy for mitigating current climate challenges by reducing carbon footprints in building lifecycles beyond the immediate energy savings by the solar reflective coating applications, as the manufacturing of these materials can directly store CO₂ around room temperature.

The incorporation of bioderived polymeric additives, such as polydopamine, tannins, flavonoids, and gallic acids, contributes to stabilizing metastable phases of CaCO 3, particularly the vaterite polyphase and amorphous CaCO₃ (ACC), contributing to the development of microspherical structures. In examples, the use of polydopamine serves to stabilize the vaterite phase and amorphous CaCO₃ (ACC), promoting microspherical structures. Tannins, flavonoids, and gallic acids, like polydopamine, these bioderived polymeric additives also contribute to stabilizing metastable phases of CaCO₃, particularly vaterite and ACC. Lignin can result in A CC having amorphous/spherulitic forms. Chitosan can promote calcite (in some cases), can alter crystal morphology, while the use of ellagic acid can preferentially stabilize vaterite over calcite, and the use of polyacrylic acid can lead to the formation of vaterite or calcite depending on the specific conditions. Various bioderived or bioinspired catecholic or phenolic polymers can control the phase transition of CaCO₃. By systematically introducing different ranges of CO₂ mineralization rates, yields, particle sizes, and hollow structures can serve to manipulate parameters such as CO₂ bubble size, injection rate, ingredient concentrations, and temperature, and reveal the fundamental mechanisms behind CO₂-storing mineralization in interaction with bioderived polymer additives.

The characterization of material phases, morphologies, and hollow structures, for example, hollow calcium carobonate, can be a key component to develop sustainable cool roof coating materials from CO₂ mineralization. This involves employing various techniques such as X-ray diffractometry (XRD) and microscopy to analyze the properties of the resulting CaCO₃ microspheres.

X-ray diffractometry (XRD) is a technique for determining the crystalline phase and particle size distribution of materials. In the context of the present teachings, powder X-ray diffraction (XRPD) can be used to identify the crystalline phase of the CaCO₃ microspheres and provide information on their particle size distribution. This technique is non-destructive and can be applied to various materials, making it an ideal method for characterizing the material phases of the CaCO₃ microspheres.

Scanning electron microscopy (SEM) with an energy dispersive X-ray spectrometer (EDS) or a backscattered electron detector (BSE) can provide high-resolution images of the surface features and defects of the materials, allowing for visualization of the microstructural details of the CaCO₃ microspheres. The EDS or BSE detectors can provide elemental analysis of the sample, providing and confirming information on the composition of the CaCO₃ microspheres.

Transmission electron microscopy (TEM) can be employed for high-resolution imaging and analysis of the hollow structures of the CaCO₃ microspheres. TEM provides a higher magnification than SEM, allowing for detailed observation of the internal structure of the microspheres. This technique can reveal information on the thickness of the walls and the presence of any porosity within the CaCO₃ microspheres.

Confocal laser scanning microscopy (CLSM) or atomic force microscopy (AFM) may also be used to evaluate surface properties of the CaCO₃ microspheres. These techniques can provide information on the topographic and compositional features of the surfaces, offering insights into the adhesion and durability of the CaCO₃ microspheres as cool roof coating materials.

In addition to evaluating the performance of hollow CaCO₃ microspheres as cool rooftop coating materials, their potential environmental benefits can be exploited to reduce carbon footprints in building lifecycles beyond the immediate energy savings by the solar reflective coating applications, and offer a sustainable alternative to conventional useful mineral-based coating materials that carry supply chain risks and have heavy carbon footprints associated with their manufacturing.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A method for fabricating sustainable materials, comprising:
injecting carbon dioxide gas into a reaction vessel;
injecting a mixture of comprising calcium and ammonium hydroxide (NH₄OH) into the reaction vessel;
incorporating polymeric additives into the reaction vessel; and
producing calcium carbonate (CaCO₃) from the reaction vessel.

2. The method for fabricating sustainable materials of claim 1, wherein the mixture comprises calcium chloride (CaCl₂).

3. The method for fabricating sustainable materials of claim 1, further comprising adjusting one or more physical parameters to control a phase transition of calcium carbonate (CaCO₃).

4. The method for fabricating sustainable materials of claim 3, wherein the one or more physical parameters comprise a bubble size of the carbon dioxide gas, injection rate of the carbon dioxide gas, injection rate of calcium chloride (CaCl₂), injection rate of ammonium hydroxide (NH₄OH), temperature, or combinations thereof.

5. The method for fabricating sustainable materials of claim 1, wherein the polymeric additives comprise bioderived polymers.

6. The method for fabricating sustainable materials of claim 5, wherein the bioderived polymers comprise polydopamine, tannins, flavonoids, gallic acids, or combinations thereof.

7. The method for fabricating sustainable materials of claim 1, further comprising optimizing a concentration of calcium chloride (CaCl₂).

8. The method for fabricating sustainable materials of claim 4, wherein the temperature is from about 0° C. to about 90° C.

9. The method for fabricating sustainable materials of claim 1, further comprising adjusting a concentration of ammonium hydroxide (NH₄OH) to control a phase transition of calcium carbonate (CaCO₃).

10. The method for fabricating sustainable materials of claim 1, wherein the calcium carbonate (CaCO₃) comprises a plurality of hollow microspheres.

11. The method for fabricating sustainable materials of claim 10, wherein the plurality of hollow microspheres of calcium carbonate (CaCO₃) comprise a shell thickness of from about 50 nm to about 1 micron and a diameter of from about 0.5 microns to about 10 microns.

12. The method for fabricating sustainable materials of claim 1, further comprising analyzing crystalline phase and particle size distribution of calcium carbonate (CaCO₃) using powder X-ray diffraction (XRPD).

13. The method for fabricating sustainable materials of claim 1, further comprising analyzing surface properties of calcium carbonate (CaCO₃) using microscopy techniques such as confocal laser scanning microscopy (CLSM) or atomic force microscopy (AFM).

14. A material, comprising:
a hollow calcium carbonate microsphere, wherein:
the hollow calcium carbonate microsphere has a hollow core comprising a diameter of from about to about;
the hollow calcium carbonate microsphere has a shell thickness of from about 50 nm to about 1 micron; and
the hollow calcium carbonate microsphere has an external diameter of from about to about from about 0.5 microns to about 10 microns.

15. The material of claim 14, wherein the hollow calcium carbonate microsphere comprises a vaterite polyphase.

16. The material of claim 14, wherein the hollow calcium carbonate microsphere is amorphous.

17. A method for mineralizing carbon dioxide, comprising:
injecting carbon dioxide gas into a reaction mixture of calcium and ammonium hydroxide;
injecting one or more polymers into the reaction mixture; and
forming calcium carbonate, ammonium chloride, and water; and wherein:
the calcium carbonate comprises a plurality of hollow microspheres.

18. The method for mineralizing carbon dioxide of claim 17, wherein the one or more polymers comprise catecholic polymers, phenolic polymers, or a combination thereof.

19. The method for mineralizing carbon dioxide of claim 17, wherein the one or more polymers comprise polydopamine, tannins, flavonoids, gallic acids, or a combination thereof.

20. The method for mineralizing carbon dioxide of claim 17, wherein the plurality of hollow microspheres comprise a particle size of from about 0.5 microns to about 5 microns and a wall thickness of about 10 nm to about 1 micron.
